(19) United States
(12) Patent Application Publication
(10) Pub. No.: US 2002/0001371 A1
(43) Pub. Date: Jan. 3, 2002

(54) METHOD AND APPARATUS FOR DELIVERING PERSONALIZED BROADCAST MESSAGES

(76) Inventors: RANDY G. GOLDBERG, PRINCETON, NJ (US); BRUCE LOWELL HANSON, LITTLE SILVER, NJ (US); RICHARD M. SACHS, MIDDLETOWN, NJ (US)

Correspondence Address: KENYON & KENYON, 1500 K STREET, N.W., SUITE 700, WASHINGTON, DC, 20005, US

(21) Appl. No.: 09/087,568

(22) Filed: May 29, 1998

(51) Int. Cl. H04B 17/00; H04M 1/64

(52) U.S. Cl. 379/88.22; 379/88.12

(57) ABSTRACT

A method and apparatus for delivering personalized broadcast messages is disclosed. In accordance with one embodiment of the present invention, a broadcast message that is to be delivered to several recipients is stored in a network broadcast message database. Access numbers for each intended recipient of the broadcast message are stored in a recipient database in the network. The sender of the broadcast message generates a personalized message for each intended recipient and stores each personalized message in the recipient database. A message delivery module in the network retrieves the access number for each intended recipient from the recipient database and establishes a communications connection with each intended recipient. The message delivery module also retrieves the stored personalized message that is associated with the intended recipient and the stored broadcast message from the broadcast message database. The message delivery module provides the personalized message and the broadcast message to the intended recipient.

### BACKGROUND OF THE INVENTION

The present invention relates to an apparatus and method for delivering broadcast messages. More specifically, the invention provides for personalizing broadcast messages to be delivered to a recipient by creating an individualized header message directed to the recipient and providing the header message to the intended recipient when delivering the broadcast message.

Currently, it is possible to record a general message that is to be delivered to a large group of recipients and to deliver the general message to the group of recipients by calling each recipient on the telephone and audibly playing the recorded message for each recipient. This process has utility in any context where it is desired to deliver the same message to a large number of recipients, such as in a telemarketing initiative. This process can be automated by storing telephone numbers for each intended recipient in a database and utilizing an automatic calling mechanism to access each phone number from the database, place a phone call to each phone number that is accessed from the database, and play the recorded message when the phone call is answered.

There are drawbacks, however, with the currently known methods for automatically delivering broadcast messages to intended recipients. Because the party that answers the automated phone call may be busy, or generally irritated by the large number of these types of calls that are received on a daily basis, when the answering party hears the generic, recorded, non-personalized message that is played, the party may be likely to terminate the call before listening to the entire message. Even if the answering party does listen to the entire message, because the message has not been personalized for the specific intended recipient, the recipient could be less interested in the content of the message than they would possibly be if the recipient thought that the sender of the message was interested enough in the recipient as an individual to specifically personalize the message for them. Thus, the receipt of a general, recorded, non-personalized message by an intended recipient is not likely to achieve the results desired by the sender.

Therefore, it would be desirable to provide for an apparatus and method for personalizing broadcast messages. The same broadcast message could be provided to a large number of intended recipients; however, the delivery of the broadcast message would be personalized for each intended recipient.

### SUMMARY OF THE INVENTION

The drawbacks in the prior art are overcome by the present invention in which a method and apparatus deliver personalized broadcast messages. In accordance with one embodiment of the present invention, a broadcast message that is to be delivered to several recipients is stored in a network broadcast message database. Access numbers for each intended recipient of the broadcast message are stored in a recipient database in the network. The sender of the broadcast message generates a personalized message for each intended recipient and stores each personalized message in the recipient database. A message delivery module in the network retrieves the access number for each intended recipient from the recipient database and establishes a communications connection with each intended recipient. The message delivery module also retrieves the stored personalized message that is associated with the intended recipient and the stored broadcast message from the broadcast message database. The message delivery module provides the personalized message and the broadcast message to the intended recipient.

In this manner, the present invention provides for delivering a personalized broadcast message to an intended recipient. Each intended recipient receives the same broadcast message; however, the delivery of the broadcast message is preceded by a personalized header message. The efficiencies that result from automating the delivery of a recorded broadcast message to a large number of individuals can still be achieved while personalizing the broadcast message for each intended recipient.

### BRIEF DESCRIPTION OF THE DRAWINGS

FIG. 1 illustrates a personalized broadcast message delivery system in accordance with one embodiment for the present invention.

FIG. 2 illustrates an alternative embodiment for the recipient database as illustrated in FIG. 1.

FIG. 3 illustrates a process flow chart for the method steps in practicing one embodiment of the present invention.

### DETAILED DESCRIPTION

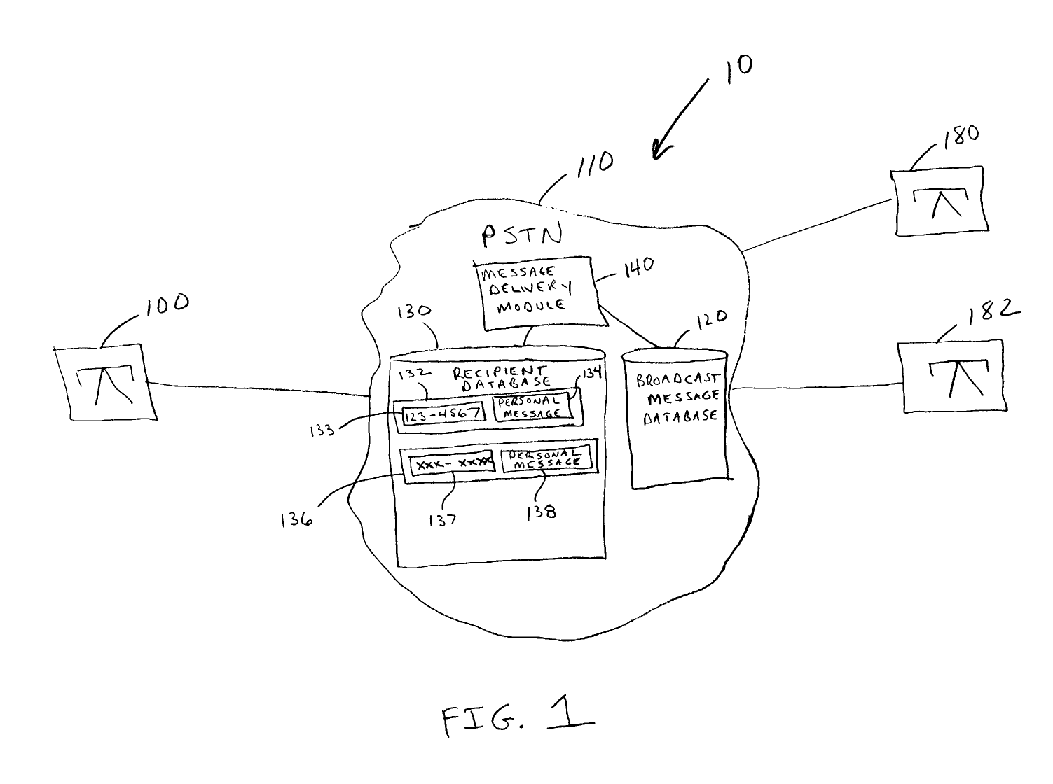

FIG. 1 illustrates one embodiment for the personalized broadcast message delivery system 10 of the present invention. As can be seen, Public Switched Telephone Network (PSTN) 110 contains a broadcast message database 120, a recipient database 130, and an automated message delivery module 140. Network 110 delivers a personalized broadcast message to the intended recipients at communication devices 180 and 182.

In practicing the present invention, a sending party who desires to send the same broadcast message to a number of intended recipients stores the broadcast message in broadcast message database 120. The broadcast message can relate to any subject matter; however, the subject matter is likely to be general in nature such that the same message is of interest to numerous intended recipients. An example of a broadcast message could be “Here is the information that I was instructed to send you. The new product will be tested on March 31st.”

The sender of the message utilizes communications device 100 to access network 110 to provide the broadcast message to the network for storage in broadcast message database 120. Network 110 can be any of a variety of networks, including a public switched telephone network or an integrated services provider network. All that is required is that network 110 be capable of providing a broadcast message to a number of intended recipients. In the disclosed embodiment of FIG. 1, network 110 is discussed as a public switched telephone network (PSTN) and both the sender's communication device 100 and the intended recipients' communications devices 180 and 182 will be described as telephones. Thus, the sender of the broadcast message will call into network 110 by utilizing telephone 100 and will speak the broadcast message. Network 110 will record the broadcast message and store it in broadcast message database 120.

Recipient database 130 contains information related to each intended recipient for the broadcast message. The database stores data files that are associated with the various particular intended recipients. Data files 132 and 136 are depicted in FIG. 1 and, for purposes of illustration, are associated with the intended recipients at telephones 180 and 182, respectively. Each recipient data file contains an access number for communicating with the intended recipient and a personalized message that is specifically tailored to apply to that particular intended recipient. As such, recipient data file 132 contains an access number data entry field 133 and a personal message data entry field 134 for the recipient at telephone 180. Recipient data file 136 contains access number data entry field 137 and personal message data entry field 138 for the intended recipient at telephone 182. Since the data files 132 and 136 for the intended recipients at telephones 180 and 182, respectively, contain similar information, a discussion of only data file 132 will be provided.

In data file 132, which contains information related to the intended recipient at telephone 180, an access number for the intended recipient and a personal message for the intended recipient are contained in data entry fields 133 and 134, respectively. The access number for the intended recipient is the telephone number for the intended recipient's telephone 180. Message delivery module 140 utilizes the access number to establish a communications connection with the intended recipient. Data entry field 134 contains a personal message that is associated with the intended recipient represented by data file 132. The personal message can be any message. The purpose of the message is to personalize to some extent the general broadcast message for the intended recipient. In the example mentioned previously, where the broadcast message stored in database 120 was “Here is the information that I was instructed to send you. The new product will be tested on March 31st”, an exemplary personal message that could be stored in data field 134 for delivery to the recipient at telephone 180 could be “Hello Joe, how are you doing?”. In this example, the intended recipient at telephone 180 is named Joe and the sender of the message is directly tailoring the delivery of the broadcast message to that particular intended recipient.

The access number and personal message for each intended recipient are input into network 110 in a manner similar to the methodology for inputting the broadcast message into network 110. That is, the sending party can audibly input the information into network 110 by utilizing the sender's telephone and by calling into network 110.

Message delivery module 140 automatically delivers the personalized broadcast messages to the intended recipients. Message delivery module 140 accesses the data file for each intended recipient. For example, to deliver the personalized broadcast message addressed above to the recipient at telephone 180, delivery module 140 accesses data file 132 to determine the access number for the recipient at phone 180. As mentioned previously, in this example, since the personalized broadcast message is to be delivered to the intended recipient's telephone 180, the access number stored in data field 133 is the telephone number for the intended recipient. Message delivery module 140 utilizes the telephone number for the intended recipient to establish a telephone call with the intended recipient, as is well known in the art. Message delivery module 140 also accesses the personal message for the intended recipient at telephone 180 that is stored in data field 134 and the generalized broadcast message that is to be delivered to all intended recipients from database 120. After the call is answered by a party at telephone 180, or by an answering machine, message delivery module 140 audibly plays the personal message and the general broadcast message for the intended recipient. Thus, the message “Hello Joe, how are you doing? Here is the information that I was instructed to send you. The new product will be tested on March 31st” will be played for the intended recipient. In this manner, the general broadcast message has been personalized for the particular intended recipient at telephone 180.

Message delivery module 140 performs the same functions for each party to whom the sending party desires to send the general broadcast message. For example, to deliver the same broadcast message to the intended recipient at telephone 182, message delivery module 140 would access data file 136, which contains information related to the intended recipient at phone 182, to access the phone number for the intended recipient from data field 137 and the personal message for that intended recipient from data field 138. Message delivery module 140 would call the intended recipient's telephone 182 by utilizing the accessed phone number retrieved from data field 137 and combine the personal message accessed from data field 138 with the same general broadcast message retrieved from database 120 and deliver the combined message when the phone call is answered. In this manner, the same general broadcast message of “Here is the information that I was instructed to send you. The new product will be tested on March 31st” can be combined with a different personal message so that the delivery of the broadcast has been personalized for the intended recipient at telephone 182.

Each recipient data file that is stored in recipient database 130 and each broadcast message that is stored in broadcast message database 120 can be assigned specific identification codes so that a sending party can designate to network 110 which recipients are to receive what broadcast messages. This may be desirable since there may be a situation where multiple broadcast messages may be stored in database 120 and information related to numerous potential recipients may be stored in database 130 and at least one broadcast message is intended for fewer than all of the potential recipients referred to in database 130. The identification codes can be descriptive narrative data or numerical data. All that is required is that a sending party be able to identify each intended recipient and each broadcast message so that correlation between specific intended recipients and specific broadcast messages can be accomplished.

Additionally, each database may contain information for several different sending parties, i.e., data related to intended recipients and broadcast messages specific to a given sending party. In such a circumstance, a sending party may have their own separate account and information could be stored in the database with reference to such an account.

It is not required that a sending party generate a personal message for each intended recipient. For example, a sending party may only desire to generate a personal message for the intended recipients that are of most importance to the sending party. If a personal message is not generated for each intended recipient for which a data file has been created in recipient database 130, network 110 will query the message sender to determine if a personal message is to be created for that particular intended recipient. Network 110 will identify to the sending party each particular intended recipient for which a personal message has not been created and ask the sender if they desire to create a personal message for that intended recipient. If a personal message is to be created for that intended recipient, network 110 could prompt the sending party to create the message. Network 110 could contain a voice response system that could ask the sending party to “Please record your personalized header message for Joseph Smith and please press the pound key when your message is complete.” The sending party would then speak the message into network 110 and the network would record and store the message in the personal message data entry field in the data file for that particular intended recipient.

In identifying each intended recipient for which a personal message has not been created to the sending party, network 110 would identify each intended recipient by utilizing the identification code, addressed above, that is associated with each recipient data file. Thus, if the identification code was narrative descriptive data, the network could prompt the sender to create a personal message for “Joseph Smith” where the descriptive data “Joseph Smith” identifies a particular intended recipient data file. Alternatively, if the identification code was a numerical identifier, the network could prompt the sender to create a personal message for intended recipient “number 1” where the numerical code “number 1” identifies a particular intended recipient data file, which could be a data file associated with the intended recipient Joseph Smith.

If a sending party does not desire to create a personal message for a particular intended recipient, automated message delivery module 140 will operate as described above to deliver a general broadcast message to that particular intended recipient. However, a personal message will not be provided to that particular intended recipient when the broadcast message is provided.

Network 110 stores all information related to intended recipients in recipient database 130 until the sending party either directs network 110 to delete information related to a particular intended recipient or the sending party modifies the information related to a particular intended recipient. In this manner, different broadcast messages can be sent to the same intended recipients, or a subset thereof, without requiring the sending party to recreate a list of intended recipients and personal messages for those intended recipients each time the sender desires to send a broadcast message to those intended recipients.

Whereas it has been discussed that a personal message can be created and stored in recipient database 130 for an intended recipient of a broadcast message, the present invention is not limited to only creating and storing one personal message for each intended recipient. It may be desirable to store multiple personal messages for each intended recipient in recipient database 130. This could be desirable in the situation where several broadcast messages are to be separately delivered to an intended recipient and where a different personal message would be appropriate for each broadcast message. For example, a formal personal message, such as “Hello, Mr. Smith”, could be appropriate when delivering a business-related broadcast message and a more informal message, such as “Hello, Joe”, could be appropriate when delivering a more social-type message. Thus, multiple personal messages for each intended recipient can be stored in the recipient database.

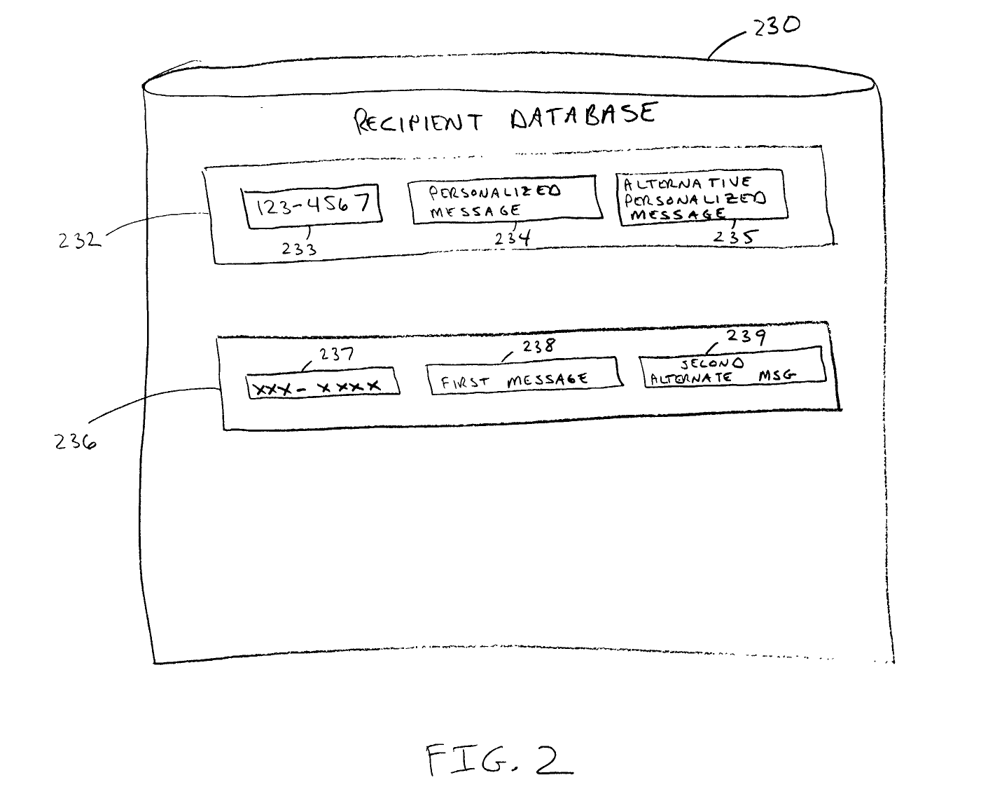

FIG. 2 illustrates an embodiment for a recipient database 230 in the present invention where the database contains multiple personal messages for an intended recipient. As illustrated, recipient data files 232 and 236 are stored in recipient database 230 for two intended recipients. Each data file contains a data entry field for an access number, as previously discussed, and two data entry fields for personal messages for each intended recipient. Thus, data file 232 contains access number data entry field 233 and personal message data fields 234 and 235. Different personal messages for the same intended recipient that is associated with data file 232 could be stored in each personal message data field. As such, a personal message can be stored in field 234 and an alternative personal message can be stored in data field 235. Similarly, for the intended recipient that is associated with data file 236, an access number can be stored in access number field 237 and different personal messages for that intended recipient can be stored in personal message fields 238 and 239.

In sending a broadcast message to a particular intended recipient where multiple personal messages are stored for that particular intended recipient, there are many ways for designating which personal message is to be delivered to the intended recipient and the present invention is not limited to any particular methodology. For example, different identification codes can be assigned to each message and the sending party could identify to network 110 which message to deliver when directing that a particular broadcast message should be delivered. Alternatively, one of the personal messages could be designated as the default message that is always to be delivered to the intended recipient unless the sending party designates otherwise to the network.

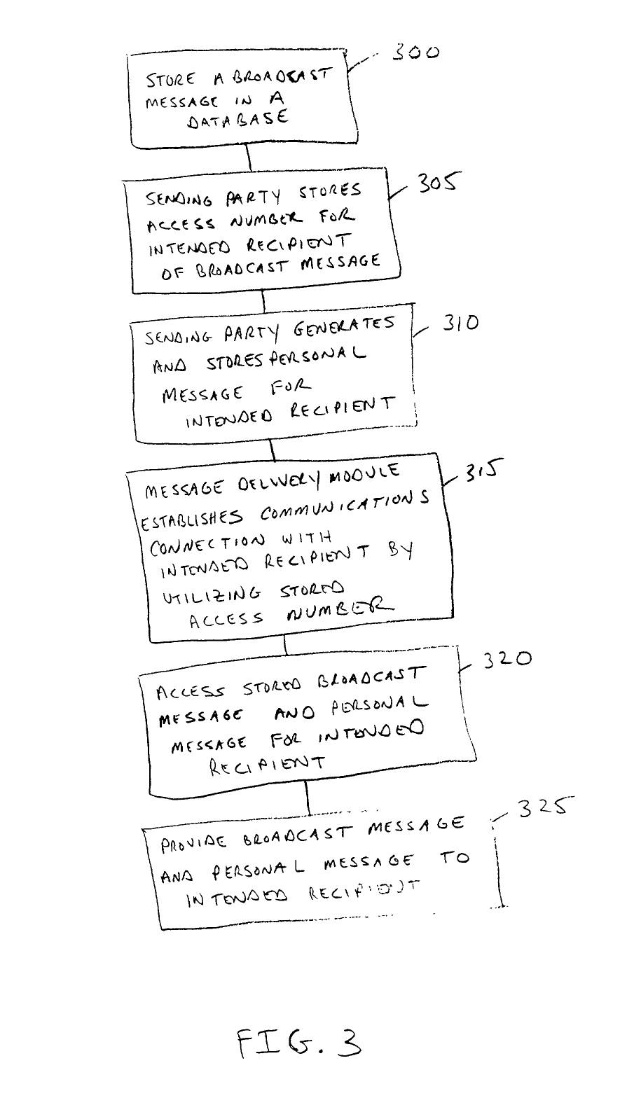

The basic method steps for practicing the present invention are illustrated in FIG. 3. As shown, in step 300 a broadcast message is stored in a database. In step 305, a sending party stores an access number for an intended recipient of the broadcast message in a database. In step 310, the sending party generates and stores a personalized message for the intended recipient in the database. As shown in step 315, a communications connection is established with the intended recipient by a message delivery module which utilizes the stored access number for the intended recipient. The broadcast message and the personalized message for the intended recipient are accessed from the database by the message delivery module, step 320. In step 325, the broadcast message and the personalized message are provided to the intended recipient over the communications connection by the message delivery module.

The method steps shown in FIG. 3 are not intended to be all inclusive of all of the features of the present invention, as described in this specification. The specification, when read as a whole, fully describes the personalized broadcast message delivery system of the present invention.

Several variations on the disclosed embodiments are contemplated. In the disclosed embodiments, the broadcast message database and the recipient database are disclosed as being separate databases; however, the functionality of these two separate databases could be provided by a single database that contains both intended recipient data and the broadcast messages. Therefore, the present invention is not limited to requiring separate databases to store recipient data and broadcast messages.

The disclosed embodiments discussed network 110 as being a telephone network and the sending party's communications device and the intended recipients' communications devices as being telephones; however, the present invention is not limited to only delivering oral personalized broadcast messages by telephone. As previously mentioned, network 110 could be an integrated services network. As such, the personalized broadcast message could be delivered as a written communication, e.g., an electronic mail (e-mail) message delivered to the intended recipient's personal computer or a facsimile document transmitted to the intended recipient's fax machine. If an e-mail broadcast message or a facsimile broadcast message was to delivered, the access number stored in the data file for the intended recipient would be the intended recipient's e-mail address or fax telephone number, as appropriate.

The present invention is also not limited to any particular methodology for the sending party to provide information to network 110 related to the intended recipients and the broadcast messages to be delivered to the intended recipients. All that is required is that the sending party provide the information to the network for further distribution to the intended recipients. For example, the sending party is not required to audibly provide the required information to network 110 by calling into the network by utilizing a telephone. The sending party could access network 110 by utilizing a personal computer interconnected to the network. The sending party could then enter the data for the intended recipients, including the personal message to be delivered, and the broadcast message to be delivered by entering a written communication into the network. If an audible personalized message was to be provided to an intended recipient in the situation where the sending party entered a written communication into network 110, the network would utilize text to speech software to transform the written input into an audible output and provide the audible output to the intended recipient.

The disclosed embodiments are illustrative of the various ways in which the present invention may be practiced. Other embodiments can be implemented by those skilled in the art without departing from the spirit and scope of the present invention.

What is claimed is:

1. A method for providing a broadcast message to an intended recipient comprising the steps of:
storing a broadcast message in a database;
storing an access number for an intended recipient of the broadcast message in said database;
storing a personalized message for the intended recipient in said database;
initializing the establishment of a communications connection with the intended recipient by utilizing said access number for the intended recipient;
accessing the broadcast message and the personalized message for the intended recipient; and
providing the broadcast message and the personalized message to the intended recipient over the communications connection.

2. The method of claim 1 wherein said access number for the intended recipient is a telephone number.

3. The method of claim 1 wherein said access number for the intended recipient is an electronic mail (e-mail) address.

4. The method of claim 1 wherein said access number for the intended recipient is a facsimile telephone number.

5. The method of claim 1 wherein said communications connection is established over a telephone network.

6. The method of claim 1 wherein said communications connection is established over an integrated services network.

7. The method of claim 1 wherein the step of providing the broadcast message and the personalized message to the intended recipient over the communications connection comprises the step of transmitting a written communication to the intended recipient.

8. The method of claim 7 wherein the written communication is an electronic mail message.

9. The method of claim 7 wherein the written communication is a facsimile document.

10. The method of claim 1 wherein the step of providing the broadcast message and the personalized message to the intended recipient over the communications connection comprises the step of transmitting an oral communication to the intended recipient.

11. The method of claim 1 wherein the step of storing a personalized message for the intended recipient comprises the steps of storing a first personalized message for the intended recipient and storing a second, alternative personalized message for the intended recipient.

12. The method of claim 11 wherein the step of accessing the broadcast message and the personalized message for the intended recipient includes the step of selecting one of said first personalized message and said second, alternative personalized message for providing the selected message to the intended recipient.

13. The method of claim 1 further comprising the step of querying a sending party of said broadcast message to determine if the sending party desires to generate a personalized message for the intended recipient.

14. The method of claim 1 wherein said stored personalized message for the intended recipient is an oral message input to said network by a sending party.

15. The method of claim 1 wherein said stored personalized message for the intended recipient is a written communication input to said network by the sending party.

16. The method of claim 1 further comprising the steps of:
storing a second broadcast message in a database;
accessing the second broadcast message and the personalized message for the intended recipient; and
providing the second broadcast message and the personalized message to the intended recipient over the communications connection.

17. An apparatus for providing a personalized broadcast message to an intended recipient via a network, comprising:
a broadcast message database;
a recipient database, said recipient database storing an access number for an intended recipient of a broadcast message and a personalized message for the intended recipient; and
a message delivery module coupled to said broadcast message database and said recipient database.

18. The apparatus of claim 17 wherein said access number for the intended recipient is a telephone number.

19. The apparatus of claim 17 wherein said access number for the intended recipient is an electronic mail (e-mail) address.

20. The apparatus of claim 17 wherein said recipient database stores a first personalized message for the intended recipient and a second, alternative personalized message for the intended recipient.

21. A method for personalizing a broadcast message delivered to an intended recipient via a network, comprising the steps of:
receiving a personalized message for an intended recipient at a network;
associating the personalized message for the intended recipient with a broadcast message to be delivered to the intended recipient; and
delivering said associated messages to the intended recipient.
